(19) United States
(12) Patent Application Publication
(10) Pub. No.: US 2008/0036945 A1
(43) Pub. Date: Feb. 14, 2008

(54) POLARIZER AND LIQUID CRYSTAL DISPLAY EMPLOYING SAME

(75) Inventor: Ga-Lane Chen, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/610,657

(22) Filed: Dec. 14, 2006

(30) Foreign Application Priority Data
Aug. 11, 2006 (CN) 200610062067.3

(51) Int. Cl. G02F 1/1335

(52) U.S. Cl. 349/95

(57) ABSTRACT

A polarizer includes an optical anisotropic transparent substrate. The substrate includes a light incident surface, a light emitting surface and a plurality of substantially elliptical grooves defined in the light emitting surface. The light emitting surface is opposite to the light incident surface. The elliptical grooves are oriented in an essentially identical direction. Each elliptical groove has a major axis and a minor axis. A length of the major axis is essentially equal to or greater than a wavelength of incident light, and a length of the minor axis is less than the wavelength of the incident light.

### BACKGROUND OF THE INVENTION

1. Field of the Invention

The present invention generally relates to polarizers and liquid crystal displays (LCDs) using the same.

2. Description of Related Art

Although most portable electronic devices such as laptop and notebook computers, mobile phones and game devices have viewing screens which are unlike the cathode-ray-tube (CRT) monitors of conventional desktop computers, users generally expect the viewing screens to provide performance equal to that of CRT monitors. To meet this demand, computer manufacturers have sought to build flat panel displays (FPDs) offering superior resolution, color and contrast, while at the same time requiring minimal power consumption. LCDs are one type of FPDs which satisfy these expectations. However, liquid crystals used in LCDs are not self-luminescent. Rather, LCDs generally need a surface-emitting device such as a backlight module which can offer sufficient luminance (i.e., brightness) in a wide variety of ambient light environments. However, light beams incident on the liquid crystal layer of the LCD must be polarized light beams because of characteristics of the liquid crystal molecules. Therefore, polarizers are used in the LCD.

Un-polarized light beams (i.e., natural light beams) emitted from the backlight module are transmitted to the polarizer. The polarizer absorbs a first polarized component of the light beams, and transmits a second orthogonally polarized component of the light beams. The second orthogonally polarized component is transmitted to the liquid crystal layer. Thus, approximately 50% of the light beams emitted by the backlight module are lost before reaching the liquid crystal layer. The second orthogonally polarized component passes through other LCD elements such as, a thin film transistor (TFT) substrate, the liquid crystal layer, and a color filter, with a result that generally no more than 20% of the light beams emitted from the backlight module is seen by the user. That is, utilization ratio of the light beams is low.

It is therefore desirable to find a new polarizer and a new liquid crystal display, which can overcome the above mentioned problems.

### SUMMARY OF THE INVENTION

A polarizer includes an optical anisotropic transparent substrate. The substrate includes a light incident surface, a light emitting surface and a plurality of substantially elliptical grooves defined in the light emitting surface. The light emitting surface is opposite to the light incident surface. The elliptical grooves are oriented in an essentially identical direction. Each elliptical groove has a major axis and a minor axis. A length of the major axis is equal to or greater than a wavelength of incident light, and a length of the minor axis is less than the wavelength of the incident light.

A liquid crystal display includes a first plate, a second plate opposite to the first plate, a liquid crystal layer, a polarizer, and a backlight module. The liquid crystal layer is sandwiched between the first plate and the second plate. The polarizer includes an optical anisotropic transparent substrate. The substrate includes a light incident surface, a light emitting surface and a plurality of substantially elliptical grooves defined in the light emitting surface. The light emitting surface is opposite to the light incident surface. The elliptical grooves are oriented in an essentially identical direction. Each elliptical groove has a major axis and a minor axis. A length of the major axis is equal to or greater than a wavelength of incident light, and a length of the minor axis is less than the wavelength of the incident light. The light emitting surface faces the second plate. The backlight module faces the light incident surface of the polarizer.

Advantages and novel features will become more apparent from the following detailed description of the present polarizer and the present display, when taken in conjunction with the accompanying drawings.

### BRIEF DESCRIPTION OF THE DRAWINGS

Many aspects of the present polarizer and the present display can be better understood with reference to the following drawings. The components in the drawings are not necessarily drawn to scale, the emphasis instead being placed upon clearly illustrating the principles of the present polarizer and the present display. Moreover, in the drawings, like reference numerals designate corresponding parts throughout the several views.

FIG. 1 is a schematic, plan view of a polarizer according to a first embodiment;

FIG. 2 is a schematic, cross-sectional view of the polarizer of FIG. 1 taken along the line II-I thereof;

FIG. 3 is a schematic, cross-sectional view of a polarizer according to a second embodiment; and

FIG. 4 is a schematic, cross-sectional view of a liquid crystal display employing the polarizer of FIG. 1;

FIG. 5 is a schematic, cross-sectional view of another liquid crystal display employing the polarizer of FIG. 1.

Corresponding reference characters indicate corresponding parts throughout the drawings. The exemplifications set out herein illustrate at least one preferred embodiment of the present polarizer and the present display, and such exemplifications are not to be construed as limiting the scope of the invention in any manner.

### DETAILED DESCRIPTION OF THE INVENTION

References will now be made to the drawings to describe preferred embodiments of the present polarizer and the present display, in detail.

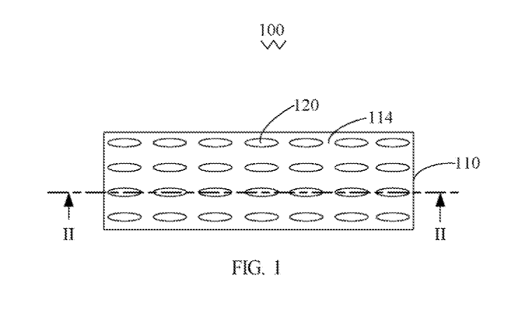

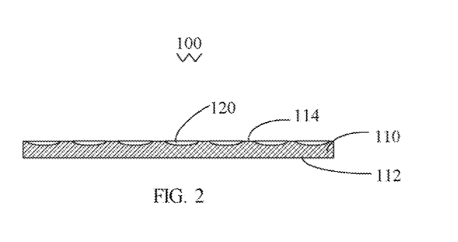

Referring to FIGS. 1 and 2, a polarizer 100 according to a first embodiment is shown. The polarizer 100 includes an optical anisotropic transparent substrate 110. The substrate 110 includes a light incident surface 112 and a light emitting surface 114. The light emitting surface 114 is opposite to the light incident surface 112. The substrate 110 defines a plurality of grooves 120 in the light emitting surface 114. The grooves 120 are oriented in an essentially identical direction.

The substrate 110 should at least allow visible light (i.e., with a wavelength from 390 to 760 nanometers) to pass therethrough. A thickness of the substrate 110 is in an approximate range from 1 to 10 millimeters (mm), and is more preferably in an approximate range from 2 to 5 mm. In the present embodiment, a material of the substrate 110 is calcite. The calcite allows a light with a wavelength in an approximate range from 350 to 2300 nanometers (nm) to pass therethrough. Alternatively, the material of the substrate 110 may be chosen from the group consisting of silicon dioxide (SiO₂), aluminum oxide (Al₂O₃), and yttrium vanadate crystal (YVO₄).

Each groove 120 is substantially elliptical with a major axis and a minor axis in cross-section cut by a plane parallel to the light incident surface 112. A depth of each groove is in an approximate range from 2 to 100 microns, and should preferably be in an approximate range from 5 to 50 microns. A length of the minor axis of the elliptical-shaped groove 120 is less than a wavelength of an incident light, and should preferably be about half that of the wavelength of the incident light. If the incident light is natural light, the above-mentioned wavelength of the incident light should be a central wavelength of the natural light (i.e., the length of the minor axis of the elliptical groove 120 should be less than the central wavelength of the natural light). A length of the major axis of the elliptical groove is equal to or greater than the wavelength of the incident light, and should preferably be approximately two times greater than the wavelength of the incident light. An aligned direction of the major axes of the grooves should be along an essentially identical direction parallel to the surface of the transparent substrate. An aspect ratio (i.e., a ratio of a length of the major axis to that of the minor axis) of the elliptical groove 120 is in an approximate range from 2 to 100, and should preferably be in an approximate range from 5 to 20. A laser treatment process may be used to define the plurality of grooves 120 in the light emitting surface 114.

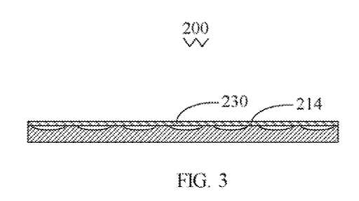

Referring to FIG. 3, a polarizer 200 according to a second embodiment is shown. The polarizer 200 is similar to the polarizer 100, but further includes an antireflective coating 230 on the light emitting surface 214. The antireflective coating 230 allows a visible light to pass therethrough. The antireflective coating 230 includes a first titanium dioxide coating with a thickness in an approximate range from 10 to 16 nm formed on the light emitting surface 214, a first silicon dioxide coating with an approximate thickness of 26 to 32 nm formed on the first titanium dioxide coating, a second titanium dioxide coating with an approximate thickness of 80 to 120 nm formed on the first silicon dioxide coating, and a second silicon dioxide coating with an approximate thickness of 78 to 86 nm formed on the second titanium dioxide coating. Interference between multiple coatings of the antireflective coating can decrease reflection of incident light.

The coating step may be a vacuum coating process. The vacuum coating process can be selected from the group consisting of electron-beam evaporation, ion-beam evaporation, magnetron sputtering deposition with shadow angle, electron spin resonance deposition, and microwave frequency enhanced deposition.

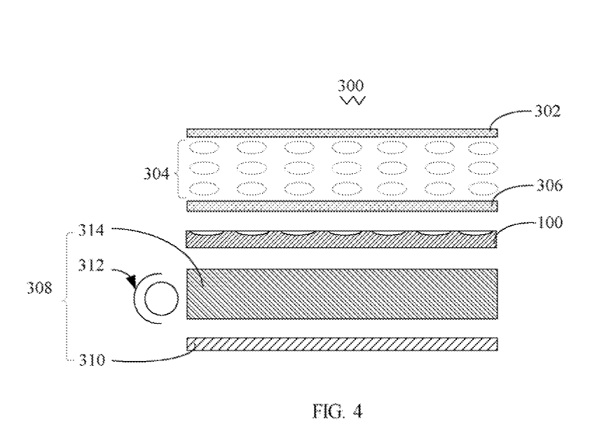

Referring to FIGS. 1, 2, and 4, a liquid crystal display 300 employing the polarizer 100 of the first embodiment is shown. The liquid crystal display 300 includes a first plate 302, a second plate 306 opposite to the first plate 302, a liquid crystal layer 304 sandwiched between the first plate 302 and the second plate 304, a polarizer 100, a backlight module 308, and a reflective plate 310. The backlight module 308 includes a light source 312, a light guide plate (LGP) 314, and a reflective plate 310. The light source 312 is disposed adjacent to the LGP 314, and the reflective plate 310 is located on a first side of the LGP 314. The light emitting surface 114 of the polarizer 100 faces the second plate 306, and the light incident surface 112 faces a second side of the LGP 314.

Light beams emitted from the backlight module 308 can be considered to be natural light beams including two linearly polarized non-coherent light beams perpendicular to each other. After passing through the substrate 110, the light is divided into two rays (i.e., an ordinary ray and an extraordinary ray) due to shape anisotropy of the substrate 110. A first ray, whose polarization direction is the same as the major axe of the grooves 120 of the polarizer 100, passes through the polarizer 100. A second ray, whose polarization direction is the same as the minor axe of the grooves 120 of the polarizer 100, scatters and then, part of the second ray is reflected by the reflective plate 310. The part of the second ray passes through the substrate 110, and is again decomposed into an ordinary ray and an extraordinary ray. In this way, a large part of the light from the backlight module 308 is converted into a light of a single linear polarization state. The light of a single linear polarization state is utilized by the liquid crystal display 300. Thus the polarizer 100 increases a light utilization ratio and a brightness of the liquid crystal display 300.

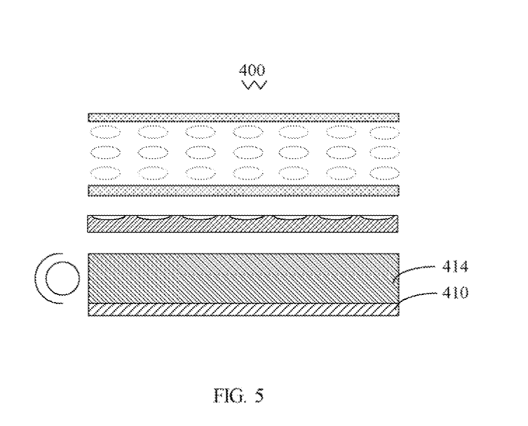

Referring to FIG. 5, another liquid crystal display 400 employing the polarizer 100 is shown. The liquid crystal display 400 is similar to the liquid crystal display 300, but a reflective film 410 is formed on a bottom surface of the LGP 414.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A polarizer comprising:
an optical anisotropic transparent substrate comprising:
a light incident surface;
a light emitting surface opposite to the light incident surface; and
a plurality of substantially elliptical grooves defined in the light emitting surface and oriented in an essentially identical direction, each elliptical groove having a major axis and a minor axis, wherein a length of the major axis is equal to or greater than a wavelength of incident light, and a length of the minor axis is less than the wavelength of the incident light.

2. The polarizer as claimed in claim 1, wherein a material of the substrate is selected from the group consisting of silicon dioxide, aluminum oxide, and yttrium vanadate crystal.

3. The polarizer as claimed in claim 1, wherein a thickness of the substrate is in an approximate range from 1 to 10 mm.

4. The polarizer as claimed in claim 1, wherein the length of the major axis is two times greater than the wavelength of the incident light.

5. The polarizer as claimed in claim 1, wherein the length of the minor axis is half less than the wavelength of the incident light.

6. The polarizer as claimed in claim 1, wherein an aspect ratio of each groove is in an approximate range from 2 to 100.

7. The polarizer as claimed in claim 1, wherein a depth of each groove is in an approximate range from 2 to 10 microns.

8. The polarizer as claimed in claim 1, further comprising an antireflective coating formed on the light emitting surface.

9. The polarizer as claimed in claim 8, wherein the antireflective coating comprises a first titanium dioxide coating with a thickness of 10 to 16 nm formed on the light emitting surface of the substrate, a first silicon dioxide coating with a thickness in an approximate range from 26 to 32 nm formed on the first titanium dioxide coating, a second titanium dioxide coating with a thickness in an approximate range from 80 to 120 nm formed on the first silicon dioxide coating, and a second silicon dioxide coating with a thickness in an approximate range from 78 to 86 nm formed on the second titanium dioxide coating.

10. A liquid crystal display comprising:
a first plate;
a second plate opposite to the second plate;
a liquid crystal layer sandwiched between the first plate and the second plate;
a polarizer disposed adjacent to the second plate, the polarizer comprising:
an optical anisotropic transparent substrate comprising:
a light incident surface;
a light emitting surface opposite to the light incident surface; and
a plurality of substantially elliptical grooves defined in the light emitting surface, and oriented in an essentially identical direction, each elliptical groove having a major axis and a minor axis, wherein a length of the major axis is essentially equal to or greater than a wavelength of incident light, and a length of the minor axis is less than the wavelength of the incident light;
a backlight module facing the light incident surface of the polarizer.

11. The liquid crystal display as claimed in claim 10, wherein the backlight module comprises a light source, a light guide plate disposed adjacent to the light source, and a reflective plate located adjacent to the light guide plate.

12. The liquid crystal display as claimed in claim 10, wherein the backlight module comprises a light source, a light guide plate disposed adjacent to the light source, and a reflective film formed on a bottom surface of the light guide plate.

13. The liquid crystal display as claimed in claim 10, wherein a material of the substrate is selected from the group consisting of silicon dioxide, aluminum oxide, and yttrium vanadate crystal.

14. The liquid crystal display as claimed in claim 10, wherein a thickness of the substrate is in an approximate range from 1 to 10 mm.

15. The liquid crystal display as claimed in claim 10, wherein the length of the major axis is two times greater than the wavelength of the incident light.

16. The liquid crystal display as claimed in claim 10, wherein the length of the minor axis is half less than the wavelength of the incident light.

17. The liquid crystal display as claimed in claim 10, wherein an aspect ratio of each groove is in an approximate range from 2 to 100.

18. The liquid crystal display as claimed in claim 10, wherein a depth of each groove is in an approximate range from 2 to 10 microns.

19. The liquid crystal display as claimed in claim 10, further comprising an antireflective coating formed on the light emitting surface.
